(19) United States
(12) Patent Application Publication
(10) Pub. No.: US 2009/0033564 A1
(43) Pub. Date: Feb. 5, 2009

(54) Deployable Antennas for Wireless Power

(75) Inventors: Nigel P. Cook, El Cajon, CA (US); David Allred, Rancho Santa Fe, CA (US)

Correspondence Address: Law Office of Scott C Harris Inc, PO Box 1389, Rancho Santa Fe, CA, 92067, US

(73) Assignee: Nigel Power, LLC

(21) Appl. No.: 11/833,178

(22) Filed: Aug. 2, 2007

(51) Int. Cl. H01Q 1/24

(52) U.S. Cl. 343/702

(57) ABSTRACT

A deployable antenna used in a mobile device. The antenna can be folded into a stowed position in which it is coplanar with the housing. It can also be unfolded, preferably to an oblique angle, and used to receive wireless power from at least 6 inches away.

### BACKGROUND

Previous applications that are commonly assigned to the present application have described sending power wirelessly from a transmitter to a receiver, using, for example, a magnetic field to induce power wirelessly into the receiver.

Transmit and receive antennas and their designs become important in this kind of system.

### SUMMARY

The present application describes a deployable antenna for use with wireless power.

### BRIEF DESCRIPTION OF THE DRAWINGS

These and other aspects will now be described in detail with reference to the accompanying drawings, wherein:

FIG. 1 shows the system used in a cellular telephone;

FIG. 2 shows the system used in a laptop computers;

FIG. 3 shows the system used with a PDA; and

FIG. 4 shows the flap unfolded to an oblique angle.

### DETAILED DESCRIPTION

The concepts of wireless power are described in detail in our patent application Ser. No. 11/775,168 filed Jul. 9, 2007 and entitled “Wireless Energy Transfer Using Coupled Antennas”, the subject matter of which is herewith expressly incorporated by reference. In general, this describes a wireless power transmitter and receiver that is capable of transmitting power over distances typically greater than six to 12 inches, and more generally between 3 inches and 6 feet.

The inventors have found, however, that bringing the wireless power receiving antenna too close to a conductive plane may reduce the power that is received. It may be desirable to use power receiving antennas of this type in various items that have conductive claims, such as PDAs, laptop computers and cell phones. However, each of these devices may have a displayed or printed circuit board that itself forms the conductive plane. A cell phone may be even more problematic, since it may use a ground plane as part of its antenna.

An aspect of the present system is to use a deployable antenna that maintains some or all of the resonator antenna more than 1/10 of a wavelength away from the device. An aspect describes the use of deployable antennas.

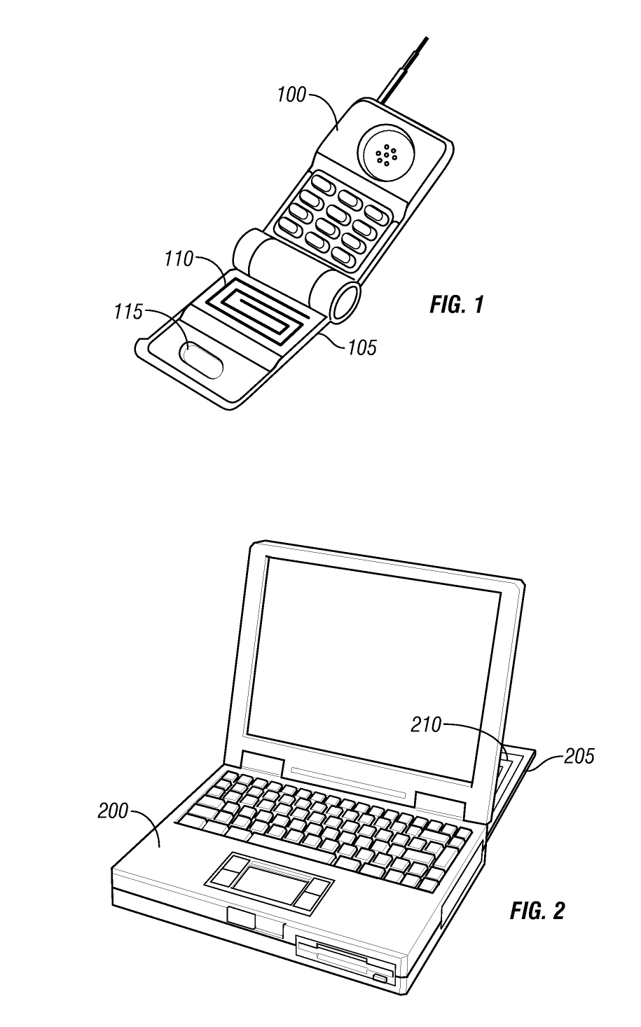

According to one aspect, the wireless power receiving antenna is embedded in a cover flap of the case. In one position, the antenna is stowed, so it is pressed firmly against the outer housing, and does not take up extra room. However, the antenna can be unfolded to its receive position. FIG. 1 illustrates the device in a cellular phone. A cellular phone 100 includes a hinged case part. When closed, that hinged case part covers some or all of the keyboard, or may be foldable onto the back portion, to cover a portion of the back portion. However, it is conventional for these hinged “flip phones” to cover some or all of the keyboard to prevent, for example, unintentional dialing. In the embodiment, the hinged portion 105 includes a receive antenna 110, of the type described in our copending application, which may include a inductive loop antenna, and a capacitor. The hinged portion may also include a microphone portion 115, preferably located towards the edge of the hinged portion, to maintain the distant from the receive antenna.

FIG. 2 illustrates the embodiment used in a laptop computer 200. In this laptop computer, the computer includes a third leaf shown as 205, which includes a loop antenna 210 embedded therein. The third leaf may normally be located underneath the laptop computer, and may be folded from the underneath into the extended position to receive power.

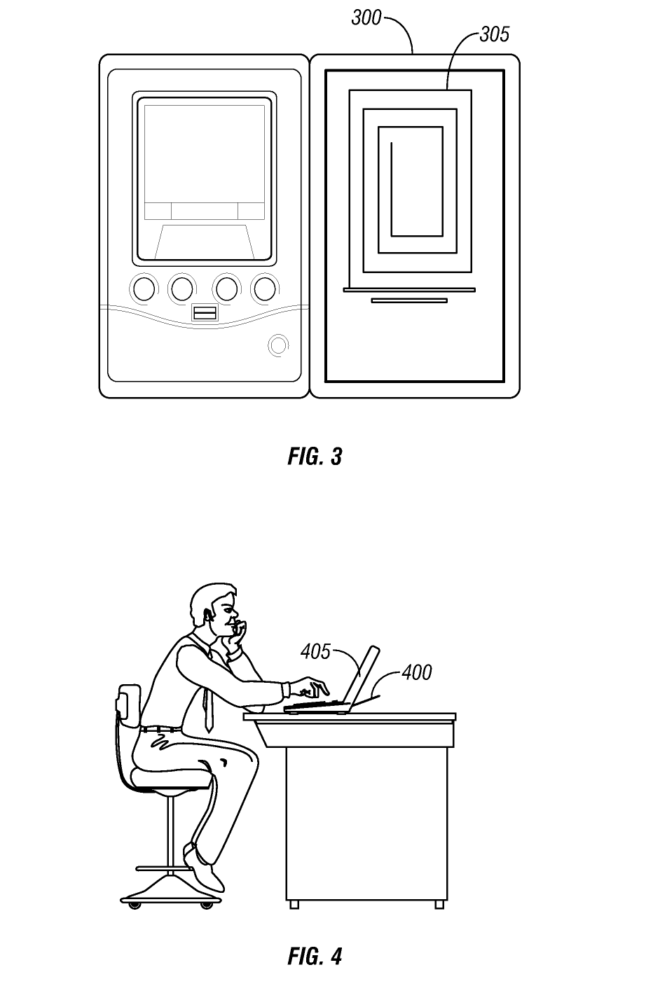

FIG. 3 illustrates the device in a PDA, where a case of the PDA 300 can be folded out to form a flap cover piece with the antenna 305 therein. Each of the devices in each of the embodiments includes a flexible ribbon cable or other flexible electronic connection between the antenna and the receive circuitry that is located within the mobile devices.

In operation, any time a user is within a charging zone, they can deploy the antenna from laptop 405 as shown in FIG. 4. When unfolded, a flap shown as 400 in FIG. 4 forms an oblique angle that is an angle other than 0° or 90°, with the main housing for all five of the laptop computers. Use of this oblique angle may prevent certain kinds of interference which could otherwise occur such as from orthogonal-induced interference. This enables charging while in the zone. The wireless power antenna can thus be integrated into the original equipment. This enables the antenna to have a proper resonant frequency that is exactly proper when the integrated into the original equipment. The resonant frequency can take into account all impedances of all the elements in the device during the time that it is being manufactured.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, this may be incorporated into other electronic devices or other devices that use power input. Another aspect, for example, may enable a foldout antenna from an automobile to charge an electronic battery that is associated therewith.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a handheld computer, such as a PDA, cellphone, or laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

1. A system comprising:
an electronic device that operates based on battery power;
wireless receive circuitry, coupled within said electronic device, that allows receiving wireless power that powers said electronic device from a distance of at least 6 inches away;
a housing, holding at least part of said electronic device; and
a foldable flap, foldably attached to said housing, said foldable flap including a wireless receive antenna therein, and said foldable flap coupled to said wireless receive circuitry via an electrical connection that can be folded.

2. A system as in claim 1, wherein said foldable flap is foldable to form an oblique angle with the main housing when in its fully unfolded position.

3. A system as in claim 1, wherein said foldable flap includes a loop antenna therein, said loop antenna being coupled in series with a capacitor.

4. A system as in claim 1, wherein said electronic device is a portable telephone.

5. A system as in claim 1, wherein said electronic device is a portable laptop computer.

6. A system as in claim 1, wherein said electronic device is a PDA, and said foldable flap is a portion of a cover of said PDA.

7. A system as in claim 1, wherein said wireless receive circuitry receives magnetic energy via an resonant connection.

8. A method, comprising:
operating an electronic device based on battery power;
unfolding a flap that is associated with the electronic device, to place that the flap relative to the electronic device in separate at least a portion of the flap from the electronic device by at least a millimeter;
using an antenna within said flap to receive wireless power from at least 6 inches away; and
using said wireless power in said electronic device.

9. A method as in claim 8, wherein said unfolding comprises unfolding said foldable flap to form an oblique angle with the main housing.

10. A method as in claim 8, further comprising maintaining an antenna within said foldable flap a resonant with a remote transmitting antenna.

11. A method as in claim 8, wherein said electronic device is a portable telephone.

12. A method as in claim 8, wherein said electronic device is a portable laptop computer.

13. A method as in claim 8, wherein said electronic device is a PDA, and said foldable flap is a portion of a cover of said PDA.

14. A method as in claim 8, further comprising folding said flap to a position where said flap is pressed against said housing, and coplanar therewith.
